(19) United States
(12) Patent Application Publication
(10) Pub. No.: US 2016/0359425 A1
(43) Pub. Date: Dec. 8, 2016

(54) Frequency Converter

(71) Applicant: VENSYS Elektrotechnik Gmbh, Diepholz (DE)

(72) Inventor: Christoph MEYER, Diepholz (DE)

(21) Appl. No.: 15/204,463

(22) Filed: Jul. 7, 2016

Related U.S. Application Data
(63) Continuation of application No. PCT/EP2015/050374, filed on Jan. 10, 2015.

(30) Foreign Application Priority Data
Jan. 10, 2014 (DE) 10 2014 000 092.3

(51) Int. Cl. H02M 5/458; H02M 1/12

(52) U.S. Cl. CPC H02M 5/458; H02M 1/12

(57) ABSTRACT

The invention relates to a frequency converter for generating a network alternating voltage, which has a predetermined main frequency component, comprising at least one converter module for converting a uniform voltage into an intermediate alternating voltage, the intermediate alternating voltage having the predetermined main frequency component and in addition thereto interference frequency components. The aim of the invention is to reduce the proportion of the interference frequency components with respect to the predetermined main frequency component of a frequency converter. For this purpose, a plurality of converter modules of the type of the at least one converter module are interconnected in a phase-shift such that the network alternating voltage is generated by a superposition of a plurality of intermediate alternating voltages, the resulting interference frequency components of said network alternating voltage being fewer than the interference frequency components of each individual intermediate alternating voltage.

The invention relates to a frequency converter for generating a mains alternating voltage having a predetermined principal frequency component with at least one converter module for converting a uniform voltage to an intermediate alternating voltage, wherein the intermediate alternating voltage has the predetermined principal frequency component and furthermore interference frequency components.

Electric power supply grids may be based on different power frequencies. Nevertheless, in order to link these grids with each other, it is necessary to use so-called frequency converters. This problem occurs for example in the supply of 16⅔ Hz rail grids, which are to be supplied from a 50 Hz grid.

Similarly, frequency converters are required at plants for the production of electrical energy—such as wind turbines or solar systems—in order to convert the generated alternating or DC voltage into a voltage with the principal frequency component imposed by the grid supply point.

If the grid supply point is part of a household grid, then the default principal frequency component is 50 Hz.

If the grid supply point is in contrast part of a rail grid, then the predetermined principal frequency component can also be 16⅔ Hz.

Frequency converters for a railway grid are known for example from DE 94 08 504 U1, DE 44 43 747 C1, EP 2 088 688 A2 or EP 2 282 399 B1.

The converters of the type described, depending on the application, can have a power transmission from a few kW to several MW. The operation of such converters is based nowadays usually on fast-switching power semiconductors, for example, bipolar transistors with insulated gate electrode (Insulated Gate Bipolar Transistor, IGBT in short). Due to the switching operations of the power semiconductors, it is inevitable that in addition to the prescribed principal frequency component also interference frequency components arise. Sometimes it is difficult or even impossible with the known frequency converters to comply with the specifications imposed on grid supply points, with reference to low interference frequency components.

The object of the invention is, therefore, to reduce the amount of interference frequency components in a frequency converter with respect to the predetermined principal frequency component.

This object is achieved by the characteristics of claim 1.

The frequency converter according to the invention for generating an alternating mains voltage having a predetermined principal frequency component comprises at least one converter module for converting a uniform voltage to an intermediate alternating voltage, wherein the intermediate alternating voltage has the predetermined principal frequency component and furthermore interference frequency components, and is characterized in that a plurality of converter modules of the type of at least one converter module are interconnected out of phase with each other in such a way that the mains alternating voltage is generated by superimposing a plurality of intermediate alternating voltages whose resulting interference frequency components are lower than the interference frequency components of each intermediate alternating voltage.

In conventional converters normally only the parameters of the clock frequency, the slope and the inductance are available for reducing interference frequency components and in order to achieve the smallest possible ripple in the principal frequency component. The optimization of these parameters is however in contrast to the simultaneous demand for the highest possible efficiency and low electromagnetic interference.

On the contrary, a particular advantage of the invention is that a further design parameter is available for designing the frequency converter according to the invention, so that a much better overall compliance with said requirements can be achieved.

According to a preferred embodiment it is provided that the converter module comprises at least one power component and a smoothing component. The at least one power component is preferably a bipolar transistor with an insulated gate electrode (Insulated Gate Bipolar Transistor, IGBT in short). As a smoothing component an inductor or a coil is preferably used.

The input power of the frequency converter is usually provided in the form of a DC voltage. The generation of the intermediate circuit alternating voltage is then accomplished by clocking the power component or the plurality of power components. By quickly switching on/off the power component, a current flows through the inductor, whose mean value is dependent on the ratio between on time and off time (pulse width modulation or PWM). To generate the pulse width modulation, various microcontrollers for various applications are available on the market.

According to the invention a plurality of intermediate alternating voltages are generated, wherein their superposition can be achieved in the simplest manner by summation at a node. The phase offset of the individual intermediate alternating voltages with respect to the particular base period is preferably—but not necessarily—equidistant. Preferably, as the fundamental period the corresponding clock of the pulse width modulation is used as a basis.

Further details and advantages of the invention are illustrated by the following figures. In particular

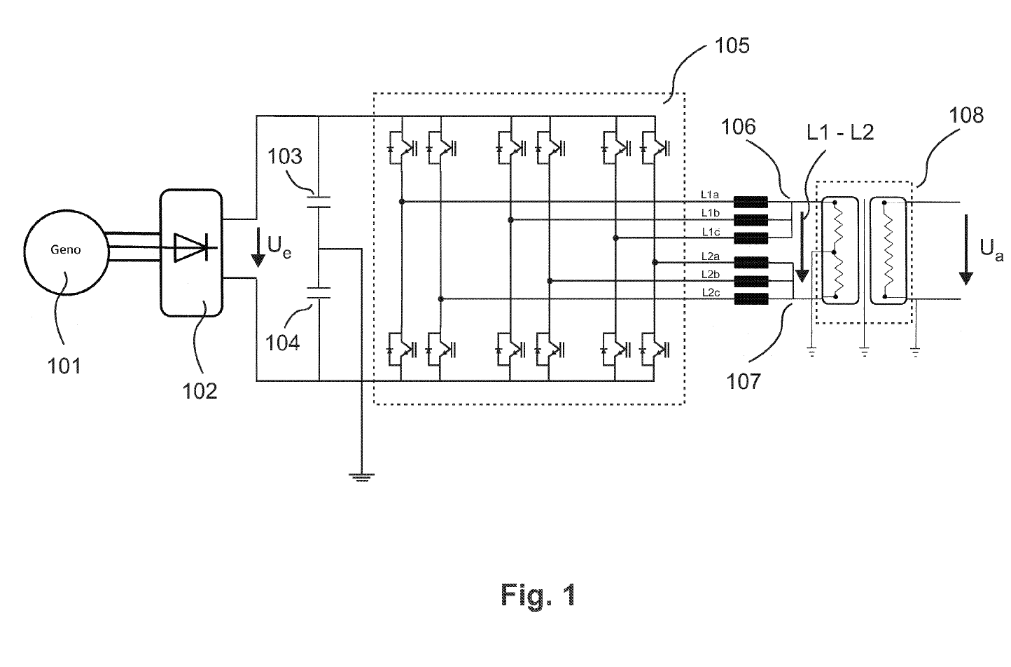

FIG. 1 is a schematic diagram of the frequency converter according to the invention,

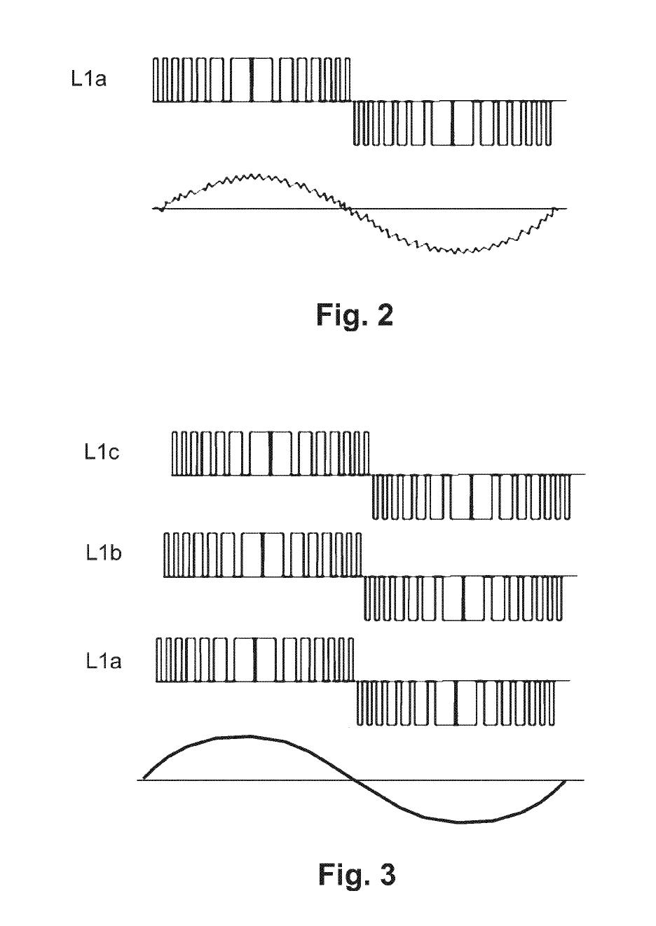

FIG. 2 is the profile of a typical intermediate alternating voltage based on a pulse width modulation,

FIG. 3 is the profile of the mains alternating voltage due to the superimposition of several intermediate alternating voltages according to the invention,

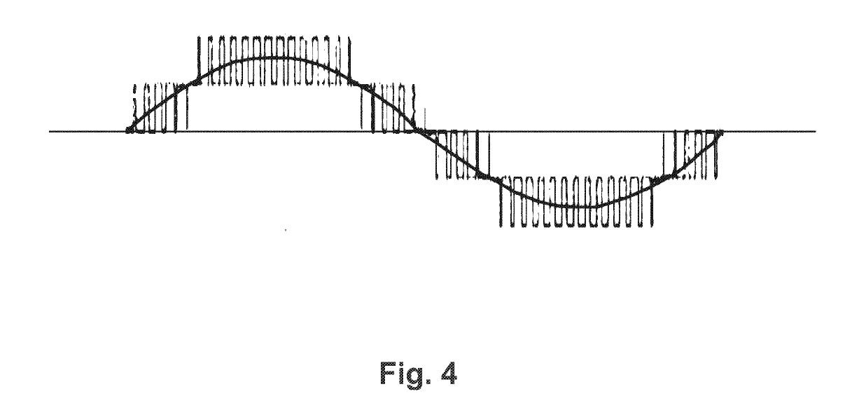

FIG. 4 is the profile of a typical intermediate alternating voltage on the basis of multiple pulse width modulations, and

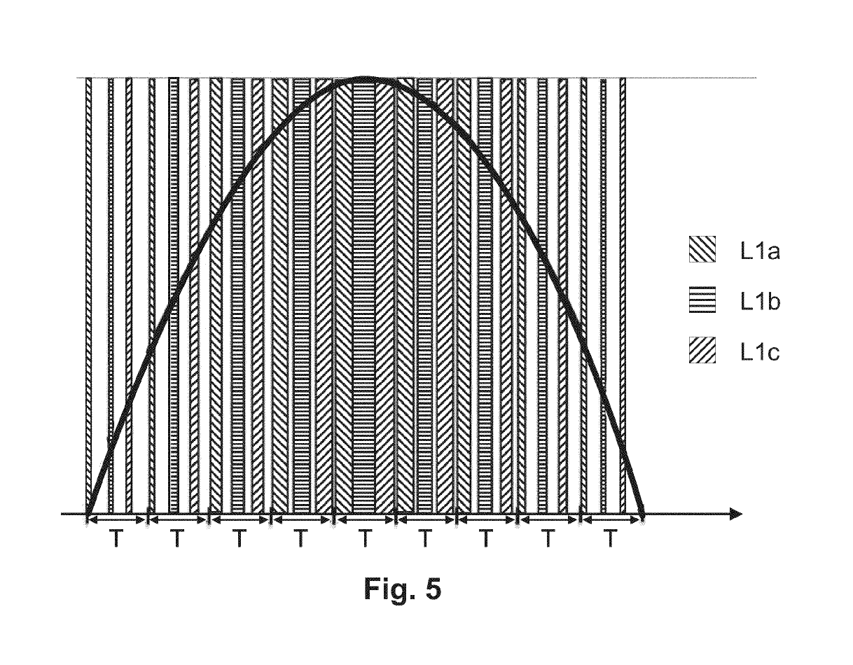

FIG. 5 is the generation of a sine half-wave according to an embodiment of the invention.

FIG. 1 shows a basic circuit diagram of the frequency converter according to the invention. In this exemplary embodiment, a uniform input voltage Uₑ has to be converted into a mains alternating voltage Uₐ at 16⅔ Hz to supply a rail grid. The uniform input voltage Uₑ can be, for example, a voltage that is locally generated by a generator 101 of a wind turbine and that is then rectified by a rectifier 102.

The capacitors 103 and 104 provide a first intermediate circuit with grounding and with a defined symmetry point. This is followed by the assembly 105 which comprises a total of 6 converter modules for converting the uniform voltage Uₑ in an intermediate alternating voltage. Each converter module in turn consists of two IGBTs with freewheeling diode and an inductor. Pulse-width modulated voltages L1a, L1b, L1c and L2a, L2b and L2c are applied on the inductors. Each of the inductors smoothes the respective pulse width modulated voltage, and generates at the output an intermediate alternating voltage, which contains the predetermined principal frequency component and the interference frequency components.

The intermediate alternating voltages are converged at the nodes 106 and 107 and form by superimposing the primary voltage L1-L2, which is applied to the primary winding of the transformer 108. The transformer 108 is designed so that from the symmetrical voltage L1-L2 with intermediate circuit ground the unilateral mains alternating voltage Uₐ for feeding into the rail grid is generated. The predetermined principal frequency component of the alternating mains voltage Uₐ is the grid frequency of the railway grid at 16⅔ Hz. At the same time, the resulting interference frequency components of the alternating grid voltage Uₐ are lower than the interference frequency components of each intermediate alternating voltage at the outputs of the 6 inductors. This effect is further explained with reference to FIG. 2 and FIG. 3.

FIG. 2 shows the profile of a typical intermediate alternating voltage based on a pulse width modulation. The upper profile of FIG. 2 corresponds to the pulse-width modulated voltage profile within a converter module, for example, the voltage profile L1a. The positive rectangular half-waves are generated by clocking the upper IGBTs of the converter module, while the negative rectangular half-waves are generated by the corresponding clocking of the lower IGBTs of the converter module. If the pulse-width modulated voltage profile L1a is then fed to an inductor, at the inductor's output, the lower sinusoidal curve in FIG. 2 is obtained. In the lower profile a fundamental component of the predetermined principal frequency component is shown, which in addition also contains interference frequency components, which is indicated by the jagged profile of the sinusoidal fundamental oscillation (sinusoidal fundamental component with harmonic and/or distortion).

FIG. 3 shows the profile of the alternating grid voltage based on the inventive superposition of several intermediate alternating voltages. As can be seen in the three upper curves in FIG. 3, the pulse-width modulated voltage profiled L1a, L1b and L1c have basically the same clocking, however, although the clocks are out of phase with each other. If now, for example, a clock L1a subsides in the subsequent inductor, the next clock of L1b already takes place out of phase, precisely so as to counter the decay of L1a by generating a further increase, resulting in a reduction of the interference frequency components. The same applies to the phase offset of L1c. At nodal point 106 thereby the lower profile of a sinusoidal fundamental component of the predetermined principal frequency wave arises, which, with respect to FIG. 2 contains notably less interference frequency components. In the same manner—and therefore not shown—is also the generation of the negative voltage component L2, such that between the nodal points 106 and 107, the resulting voltage L1-L2 is present due to the superposition of several intermediate alternating voltages.

In FIG. 2 and FIG. 3, it was assumed that an intermediate alternating voltage is generated by the

pulse width modulation having only a positive level and a negative level. Basically, it is of course also conceivable that by providing a series connection of several IGBTs, several voltage levels and thus several pulse-width modulations to generate an intermediate alternating voltage are provided. FIG. 4 shows the profile of such an intermediate alternating voltage on the basis of a plurality of pulse-width modulations with 2 positive voltage levels and 2 negative voltage levels. The intermediate alternating voltage already comprises in this case, as compared to FIG. 2, substantially less interference frequency components. If the inventive method according to FIG. 3 is applied to several intermediate alternating voltages of FIG. 4, a further reduction of the interference frequency components with respect to the lower profile in FIG. 3 can be achieved.

FIG. 5 shows the generation of a sine half-wave according to an embodiment of the invention. Before explaining the individual pulses and their effect the principle of operation of a so-called step-down converter is described:

In FIG. 1 it can be seen that each IGBT is provided with a freewheeling diode. After switching off an IGBT the current commutates—driven by the inductor—to the corresponding freewheeling diode. If one considers the inductor as an RL-element, then, if the IGBT is conducting, the current follows a rising e-function and if the IGBT is switched off, it follows a decaying e-function. The time constant τ of the e-function is determined by the ratio L/R, so that τ=L/R. From these considerations it follows then directly that the ratio of the clock period T of pulse width modulation to the time constant τ, determines the ripple of the principal frequency component. If the ratio T/τ is large, then, the principal frequency component has a large ripple. The smaller the ratio T/τ, the more the principal frequency component approaches the desired ideal shape.

These considerations imply further that in conventional frequency converters a small ripple with less interference frequency components can be achieved by the following three measures, although each of these three measures has certain disadvantages:
The clock frequency f of the pulse-width modulation (where f=l/T) is increased with a constant slope. Constant slope here means constant on/off times of respective clocks.

Disadvantage:
The switching losses increase, since the sum of the switching times per second also increases.
The clock frequency f and the slope are increased together such that the sum of switching times per second is unchanged.

Disadvantage:
The faster switching results in more EMC interference. In addition, the control losses increase.
The time constant τ is by increasing the inductance L.

Disadvantage:
Large inductors are expensive, large and heavy.

These considerations are ultimately clarified by a numerical example:

Commercial microcontrollers for generating a Pulse Width Modulation usually generate clock frequencies in the order of a few kilohertz, so for example, f=2.4 kHz. At 2.4 kHz the fundamental period T is thus approximately 0.42 ms. If a commercial inductor with L=0.3 mH and R=0.1Ω is used, then the time constant τ has values in the range of τ˜3 ms. This results in the ratio T/τ having numerical values that are significantly smaller than 1, but often insufficient for complying with the current requirements in terms of residual ripple in the power supply.

Referring to FIG. 5 it is now clearly shown again how this residual ripple can be further reduced according to the invention. First, it is assumed that the three phases L1a, L1b and L1c have a uniform phase offset with respect to the fundamental period T, i.e. the phase offset amounts to one third of the fundamental period T. A conventional frequency converter works only with one phase, so for example with phase L1a. During the off clock of phase L1a the current decays, as explained, exponentially, thus generating said residual ripple. The subsequent clocks of phase L1b and L1c thus effectively contrast this ripple.

It is of course left to the discretion of those skilled in the art to choose the location and number of phases so that by superposition of the respective intermediate alternating voltages the mains alternating voltage is generated such that its resultant interference frequency components are lower than the interference frequency component of each intermediate alternating voltage. For example, therefore, the number of phases need not necessarily be set at three. Also, two phases or more than three phases can be provided. Also, a uniform phase offset is not necessary to achieve the advantages of the invention. Depending on the application, the phases can also be irregularly distributed on the fundamental period T. Finally, it is obviously also conceivable that the individual pulses of the respective phases overlap. FIG. 5 has to be considered only as a possible exemplary embodiment, in which the pulse lengths are precisely chosen so that a clock is ended before the clock of the next phase begins.

1. Frequency converter for generating a mains alternating voltage having a predetermined principal frequency component, comprising:
at least one converter module for converting a uniform voltage in an intermediate alternating voltage, wherein the intermediate alternating voltage has the predetermined principal frequency component and furthermore interference frequency components, wherein a number of converter modules of the type of the at least one converter module are interconnected to one another with such a phase offset that by superposition of several intermediate alternating voltages a mains alternating voltage is generated, whose resultant interference frequency components are lower than the interference frequency components of each intermediate alternating voltage.

2. Frequency converter according to claim 1, wherein the at least one converter module comprises at least one power component and a smoothing component.

3. Frequency converter according to claim 2, wherein the at least one power component is a bipolar transistor with an insulated gate electrode (Insulated Gate Bipolar Transistor, IGBT).

4. Frequency converter according to claim 2, wherein the smoothing component is an inductor or a coil.

5. Frequency converter according to claim 2, wherein an intermediate circuit alternating voltage is generated by clocking of the at least one power component.

6. Frequency converter according to claim 5, wherein the clock is based on a pulse width modulation.

7. Frequency converter according to claim 1, wherein the superposition of the individual intermediate alternating voltages is provided by summation at one nodal point.

8. Frequency converter according to claim 1, wherein the phase offset of the individual intermediate alternating voltages with respect to the respective fundamental period is equidistant.
